(19) United States
(12) Patent Application Publication
(10) Pub. No.: US 2014/0133451 A1
(43) Pub. Date: May 15, 2014

(54) Identifier Allocation Method and System

(71) Applicants: Nan Li, Shenzhen (CN); Weimin Xing, Shenzhen (CN); Kaiying Lv, Shenzhen (CN); Bo Sun, Shenzhen (CN); Jing Jiang, Shenzhen (CN)

(72) Inventors: Nan Li, Shenzhen (CN); Weimin Xing, Shenzhen (CN); Kaiying Lv, Shenzhen (CN); Bo Sun, Shenzhen (CN); Jing Jiang, Shenzhen (CN)

(73) Assignee: ZTE CORPORATION, Shenzhen, Guangdong (CN)

(21) Appl. No.: 14/232,755

(22) PCT Filed: Jun. 20, 2012
(86) PCT No.: PCT/CN2012/077252

§ 371 Date: Jan. 14, 2014

(30) Foreign Application Priority Data
Jul. 27, 2011 (CN) 201110212387.3

(51) Int. Cl. H04L 5/00

(52) U.S. Cl. CPC H04L 5/003
USPC 370/329

(57) ABSTRACT

The disclosure discloses an Identifier (ID) allocation method, including that: a non-AP Station (STA) sends a first radio frame to an Access Point (AP); and the AP sends a second radio frame to the STA, wherein the second radio frame carries group ID information or group ID information and second station ID information allocated to the STA. In a case that the STA sends a Reassociation Request frame to the AP, the AP may also send the STA a Reassociation Response frame carrying group ID information and/or station ID information reallocated to the STA. Correspondingly, the disclosure further discloses an ID allocation system. With the disclosure, a terminal is distinguished by the group ID information and the station ID information, such that it is possible to avoid Association ID (AID) shortage and support group management of terminals.

### TECHNICAL FIELD

The disclosure relates to the field of Wireless Local Area Network (WLAN) communications, in particular to an Identifier (ID) allocation method and an ID allocation system.

### BACKGROUND

At present, a demand for WLAN coverage grows continuously with the rapid development of WLAN in the field of wireless networks. The group working on Institute of Electrical and Electronic Engineers (IEEE) industrial specification IEEE 802.11 defines in time a series of WLAN technical standards, such as 802.11a, 802.11b and 802.11g. Since then, other task groups appear successively committed to development of improved specifications over the existing 802.11 standard. For example, the 802.11n task group puts forward a requirement for High Throughput (HT) supporting a data rate up to 600 Mbps. As an evolution of 802.11n, the 802.11ac task group further puts forward the concept of Very High Throughput (VHT) boosting the data rate to 1 Gbps. Further include in the 802.11 family are 802.11ad supporting operation at 60 GHZ and 802.11ah supporting operation at or below 1 GHz.

In 802.11, an Access Point (AP) and a plurality of non-AP Stations (STAs) associated with the AP form a Basic Service Set (BSS). The basic principle of 802.11 is to share a wireless channel among a plurality of stations using a Carrier Sense Multiple Access with Collision Avoidance (CSMA/CA) mechanism and a backoff algorithm.

A general process of accessing an AP by an STA is as follows: the STA acquires a system information parameter of a BSS by sending a Probe Request frame and receiving a Probe Response frame returned by the AP or by receiving a Beacon frame broadcasted by the AP. The STA sends an Authentication Request frame to the AP for authentication, and the AP returns an Authentication Response frame to indicate whether the authentication is successful. After the authentication succeeds, the STA sends an Association Request frame for association, and the AP returns an Association Response frame to indicate whether the association is successful, and allocates ID information, called Association Identifier (AID), for the STA in the Association Response frame. The STA completes the basic accessing process when the authentication and the association conclude. Similarly, a process of reassociation is as follows: the STA exchanges a Reassociation Request frame and a Reassociation Response frame with the original AP or another AP in the same BSS to complete the reassociation.

At present, Internets of things are booming globally and a communication network serves as a foundation and a bridge in implementation of a Internet of things. Therefore, the WLAN is widely employed in existing Internets of things owing to features such as low cost, easy networking, and high security thereof. An Internet of things, such as smart grid, an environment monitoring terminal, or a Smart Home system, is typically characteristic of massive terminals. With the large-scale rapid development of wireless-network based Internet-of-things applications, the number of STAs accessing via one AP grows rapidly, leading to AID shortage of a conventional AP. In addition, terminals may be managed in groups in an Internet of things. However, no proper solution is proposed in prior art for the terminal-ID-allocation flow in group management of massive terminals in the WLAN.

### SUMMARY

In view of this, it is desired that an embodiment of the disclosure provides an ID allocation method and an ID allocation system, capable of avoiding AID shortage and supporting group management of terminals.

Accordingly, a technical solution of an embodiment of the disclosure is implemented as follows.

An Identifier (ID) allocation method includes that:

a non-AP Station (STA) sends a first radio frame to an Access Point (AP); and

the AP sends the STA a second radio frame carrying group ID information allocated to the STA, or carrying group ID information and second station ID information allocated to the STA.

The method may further include that: before the STA sends the first radio frame to the AP,

the STA sends an Association Request frame/a Reassociation Request frame to the AP; and

the AP sends the STA an Association Response frame/a Reassociation Response frame carrying a first station ID information of the STA.

The group ID information carried by the second radio frame may be group ID information allocated to the STA by the AP according to an ID allocation parameter carried by the first radio frame and/or capability information of the STA acquired from a Probe Request frame and/or an Association Request frame/a Reassociation Request frame; and

the group ID information and the second station ID information carried by the second radio frame may be group ID information and second station ID information allocated to the STA by the AP according to the ID allocation parameter carried by the first radio frame and/or the capability information of the STA acquired from a Probe Request frame and/or an Association Request frame/a Reassociation Request frame; and the second station ID information can be the same as or different from a first station ID information.

The ID allocation parameter may include one or more of the following: a category of application, a provider ID, a power-saving capability, and an operator ID of the STA.

The method may further include that: before the AP sends the second radio frame to the STA, the AP, or a network entity located at the same layer as or at a layer higher than the AP is, allocates the group ID information to the STA, or allocates the group ID information and the second station ID information to the STA.

The ID allocation parameter, the group ID information and the second station ID information may be carried by a message defined by a Media Access Control (MAC) layer or its upper layer.

An Identifier (ID) allocation method includes that:

a non-AP Station (STA) sends a Reassociation Request frame to an Access Point (AP); and

the AP sends the STA a Reassociation Response frame carrying group ID information and/or station ID information reallocated to the STA.

The method may further include that: before the AP sends the Reassociation Response frame to the STA, the AP, or a network entity located at the same layer as or at a layer higher than the AP is, allocates the group ID information and/or the station ID information to the STA according to an acquired ID allocation parameter and/or capability information of the STA acquired from an Association Request frame/the Reassociation Request frame.

The ID allocation parameter may include one or more of the following: a category of application, a provider ID, a power-saving capability, and an operator ID of the STA.

An Identifier (ID) allocation system includes a non-AP Station (STA) and an Access Point (AP), wherein

the STA is configured to send a first radio frame to the AP; and

the AP is configured to send the STA a second radio frame carrying group ID information allocated to the STA, or group ID information and second station ID information allocated to the STA.

The STA may be further configured to send an Association Request frame/a Reassociation Request frame to the AP; and

the AP may be further configured to send the STA an Association Response frame/a Reassociation Response frame carrying a first station ID information of the STA.

The AP may be further configured to allocate the group ID information to the STA, or allocate the group ID information and the second station ID information to the STA.

The system may further include a network entity located at the same layer as or at a layer higher than the AP is, the network entity being configured to: allocate the group ID information to the STA, or allocate the group ID information and the second station ID information to the STA; and send the allocated ID information to the AP. The second station ID information may or may not be the same as the first station ID information.

An Identifier (ID) allocation system includes a non-AP Station (STA) and an Access Point (AP), wherein

the STA is configured to send a Reassociation Request frame to the AP; and

the AP is configured to send the STA a Reassociation Response frame carrying group ID information and/or station ID information reallocated to the STA.

The AP may be further configured to allocate the group ID information and/or the station ID information to the STA according to an acquired ID allocation parameter and/or capability information of the STA acquired from an Association Request frame/a Reassociation Request frame.

The system may further include a network entity located at the same layer as or at a layer higher than the AP is, the network entity being configured to allocate the group ID information and/or the station ID information to the STA according to an acquired ID allocation parameter and/or capability information of the STA acquired from a Reassociation Request frame, and send the allocated ID information to the AP.

With the ID allocation method and the ID allocation system provided by the embodiments of the disclosure, an STA sends a first radio frame to an AP; and the AP sends the STA a second radio frame carrying group ID information or group ID information and second station ID information allocated to the STA. In a case that the STA sends a Reassociation Request frame to the AP, the AP may also send the STA a Reassociation Response frame carrying group ID information and/or station ID information reallocated to the STA. With embodiments of the disclosure, a terminal is distinguished by the group ID information and the station ID information, such that it is possible to avoid AID shortage and support group management of terminals.

### BRIEF DESCRIPTION OF THE DRAWINGS

FIG. 1 is a flowchart of an ID allocation method according to an embodiment of the disclosure;

FIG. 2 is a flowchart of allocating ID information by an AP during association according to the disclosure;

FIG. 3 is a flowchart of allocating ID information by a network entity at the same layer as an AP or at a higher layer during association according to the disclosure;

FIG. 4 is a flowchart of another ID allocation method according to an embodiment of the disclosure;

FIG. 5 is a schematic diagram of a parametrical structure according to the disclosure;

FIG. 6 is a schematic diagram of another parametrical structure according to the disclosure;

FIG. 7 is a schematic diagram of another parametrical structure according to the disclosure; and

FIG. 8 is a schematic diagram of another parametrical structure according to the disclosure.

### DETAILED DESCRIPTION

According to embodiments of the disclosure, a non-AP Station (STA) sends a first radio frame to an Access Point (AP); and the AP sends a second radio frame to the STA, wherein the second radio frame carries group ID information or group ID information and second station ID information allocated to the STA. In a case that the STA sends a Reassociation Request frame to the AP, the AP may also send the STA a Reassociation Response frame carrying group ID information and/or station ID information reallocated to the STA.

The disclosure is proposes given that there is no terminal-ID allocation method based on group management of massive terminals in a WLAN disclosed in related art, to which end it is desired that an embodiment of the disclosure provides a terminal-ID allocation method.

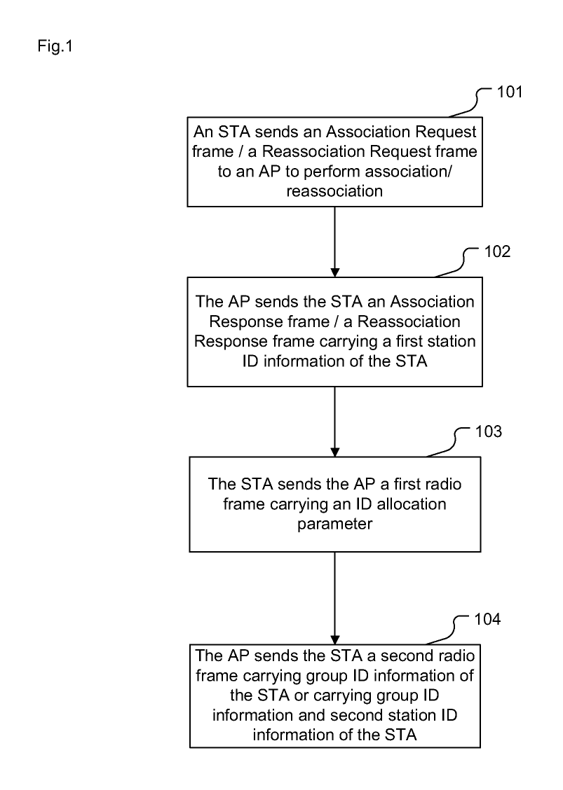

FIG. 1 is a flowchart of an ID allocation method according to an embodiment of the disclosure, as shown, the flow includes steps as follows.

Step 101: An STA sends an Association Request frame/a Reassociation Request frame to an AP to perform association/reassociation.

Step 102: After receiving the Association Request frame/Reassociation Request frame, the AP sends the STA an Association Response frame/a Reassociation Response frame carrying a first station ID information of the STA. Then, frame exchanging transmission may be performed between the STA and the AP.

Step 103: The STA sends the AP a first radio frame carrying an ID allocation parameter.

Here, the ID allocation parameter includes one or more of the following: a category of application, a provider ID, a power-saving capability, and an operator ID of the STA.

Step 104: The AP sends the STA a second radio frame, wherein the second radio frame carries group ID information allocated to the STA according to the ID allocation parameter and/or capability information of the STA acquired from a Probe Request frame and/or an Association Request frame/a Reassociation Request frame, or the second radio frame carries group ID information and second station ID information allocated to the STA according to the ID allocation parameter and/or capability information of the STA acquired from the Probe Request frame and/or the Association Request frame/the Reassociation Request frame. The second station ID information can be the same as or different from the first station ID information.

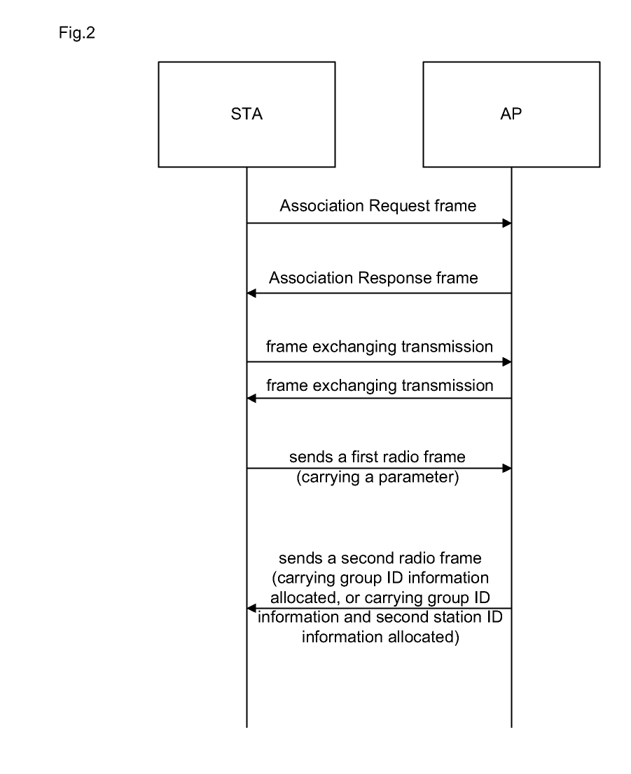

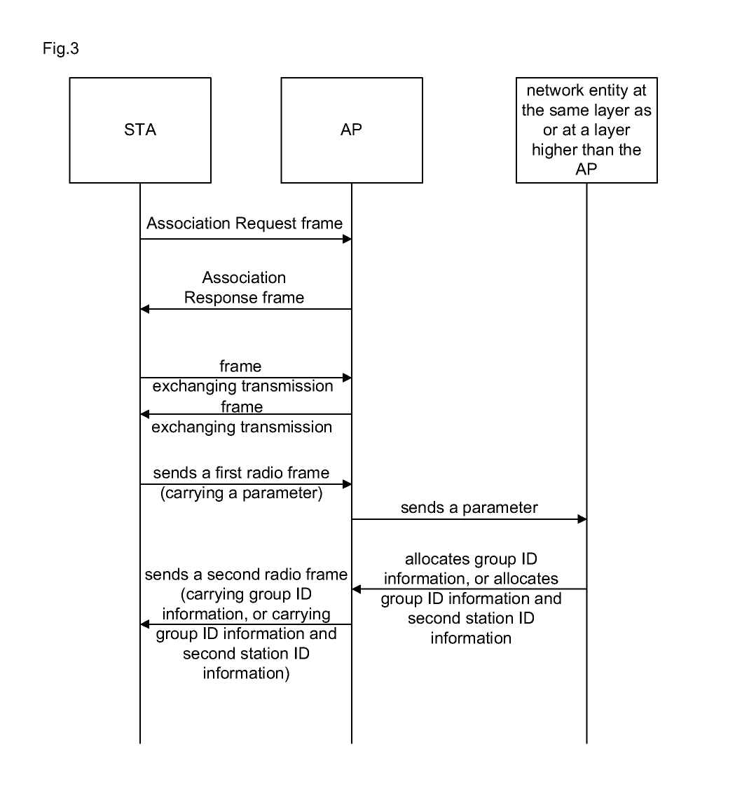

Here, the group ID information or the second station ID information can be allocated by the AP or by a network entity located at the same layer as or at a layer higher than the AP is. For example, during association, a case of allocation by the AP is as shown in FIG. 2, and a case of allocation by the network entity at the same layer as or at a higher layer is as shown in FIG. 3. The AP, or the network entity located at the same layer as or at a layer higher than the AP is, allocates the group ID information and the second station ID information to the STA specifically according to at least one of the following parameters: a category of application, a provider ID, a power-saving capability, and an operator ID of the STA. The parameters, the group ID information and the second station ID information are carried by a message defined by a Media Access Control (MAC) layer or its upper layer.

Note that in the case that the second radio frame carries only the group ID information, the station ID information allocated in Step 102 is used by default.

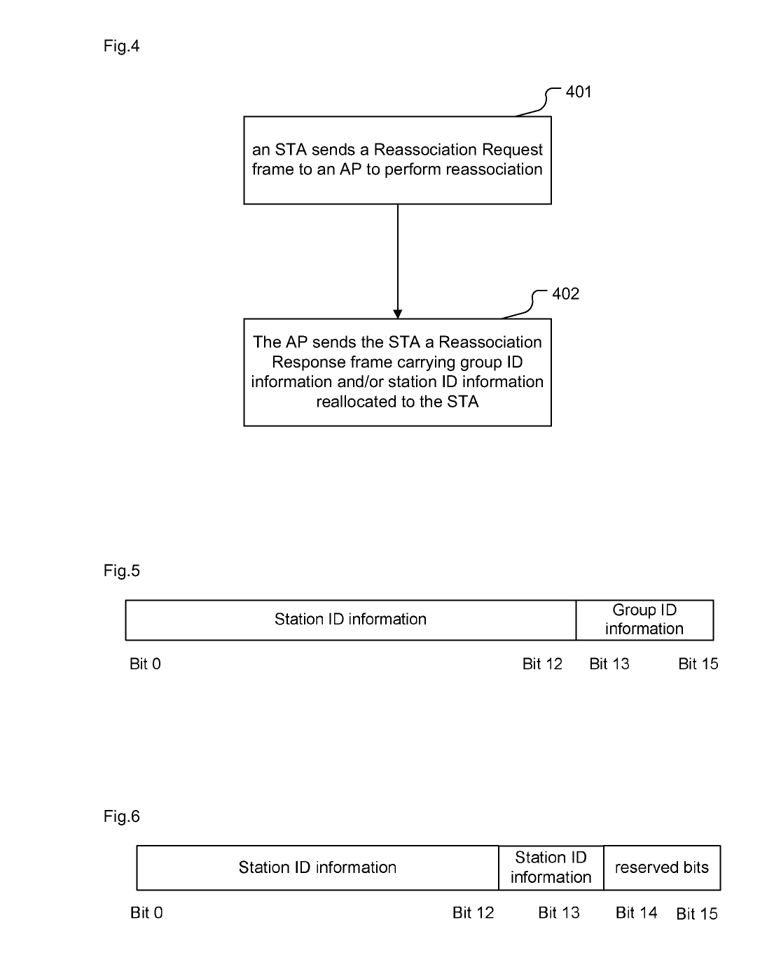

FIG. 4 is a flowchart of another ID allocation method according to an embodiment of the disclosure, as shown, the flow includes steps as follows.

Step 401: An STA sends a Reassociation Request frame to an AP to perform reassociation.

Step 402: After receiving the Reassociation Request frame, the AP sends the STA a Reassociation Response frame carrying group ID information and/or station ID information reallocated to the STA. Then, the STA performs frame exchanging transmission with the AP using the group ID information and/or the station ID information.

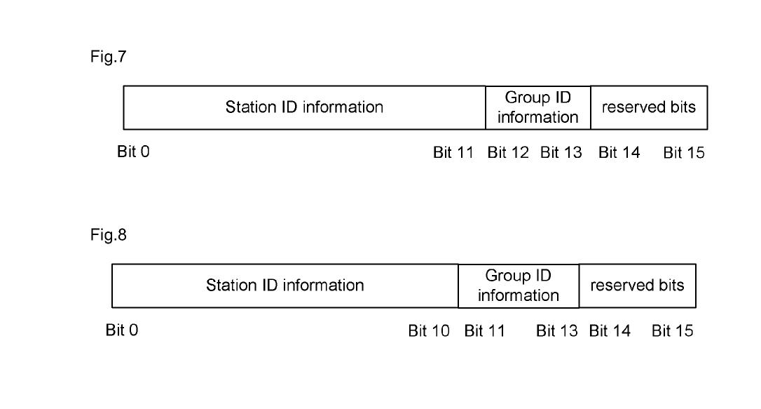

Note that in the disclosure, each STA is identified by the group ID information and the station ID information, for example with the parametrical structure as shown in FIG. 5, FIG. 6, FIG. 7, or FIG. 8.

In FIG. 5, the group ID information and the station ID information take two bytes altogether, wherein the lower thirteen bits (bit 0 to bit 12) are for the station ID information, and bit 13 to bit 15 are for the group ID information. Thereby, a BSS can support a maximal number of 2³ groups, and each group can support a maximal number of 2¹³ STAs.

In FIG. 6, the group ID information and the station ID information take two bytes altogether, wherein the lower thirteen bits are for the station ID information, bit 13 is for the group ID information, and the top two bits are reserved for future extension. Thereby, a BSS can support a maximal number of 2 groups, and each group can support a maximal number of 2¹³ STAs.

In FIG. 7, the group ID information and the station ID information take two bytes altogether, wherein the lower twelve bits are for the station ID information, bit 12 and bit 13 are for the group ID information, and the top two bits are reserved. Thereby, a BSS can support a maximal number of 2² groups, and each group can support a maximal number of 2¹² STAs.

In FIG. 8, the group ID information and the station ID information take two bytes altogether, wherein the lower eleven bits (bit 0 to bit 10) are for the station ID information, bit 11 to bit 13 are for the group ID information, and the top two bits are reserved for future extension. Thereby, a BSS can support a maximal number of 2³ groups, and each group can support a maximal number of 2¹¹ STAs.

Correspondingly, the disclosure further provides an ID allocation system, including an STA and an AP, wherein

the STA is configured to send a first radio frame to the AP; and

the AP is configured to send the STA a second radio frame carrying group ID information or group ID information and second station ID information allocated to the STA.

The STA is further configured to send the AP an Association Request frame/a Reassociation Request frame; and

the AP is further configured to send the STA an Association Response frame/a Reassociation Response frame carrying a first station ID information of the STA.

The AP is further configured to allocate the group ID information or the group ID information and the second station ID information to the STA.

The system further includes a network entity located at the same layer as or at a layer higher than the AP is, wherein the network entity is configured to allocate the group ID information or the group ID information and new station ID information to the STA, and send the allocated ID information to the AP.

Correspondingly, the disclosure further provides an ID allocation system, including an STA and an AP, wherein

the STA is configured to send a Reassociation Request frame to the AP; and

the AP is configured to send the STA a Reassociation Response frame carrying group ID information and/or station ID information reallocated to the STA.

The AP is further configured to allocate the group ID information and/or the station ID information to the STA.

The system further includes a network entity located at the same layer as or at a layer higher than the AP is, wherein the network entity is configured to allocate the group ID information or the station ID information to the STA and send the allocated ID information to the AP.

A technical solution of the disclosure is described below with specific embodiments, and it should be understood that the embodiments described herein are only intended to describe and explain the disclosure instead of limiting the disclosure. In the case of no conflict, the embodiments of the disclosure and features therein can be combined with each other as long as no conflict results from the combination. In the embodiments of the disclosure, specifically, an access point is AP and an non-AP station is STA.

### First Embodiment

This is an embodiment for allocating ID information to an STA after association.

Specifically, the STA sends an Association Request frame to an AP to perform association; and after receiving the Association Request frame, the AP sends the STA an Association Response frame carrying a first station ID information (Association ID) allocated to the STA.

After the association, the STA performs frame exchanging transmission with the AP using the AID. The STA sends a first high-layer message to the AP; and the AP sends a second high-layer message to the STA actively or in response to the first high-layer message from the STA. Both the first and the second high-layer messages refer to messages defined by a network entity at or above an MAC layer, and can be transmitted between the STA and the AP by being carried in a message payload at the MAC layer, namely, the first and the second high-layer messages can be transmitted by being carried respectively in the first and the second radio frames.

The first high-layer message includes at least one of the following parameters: a category of application of the STA, a provider ID of the STA, a power-saving capability of the STA, and an operator ID of the STA. The category of application of the STA includes: an intelligent meter, a sensor, a monitor, a load balancer and the like; the provider ID includes: a manufacturer ID and an agent ID, and the like; the power-saving capability of the STA includes a supported power-saving mode, a monitoring interval or a maximal idle time span, and the like; and the operator ID includes a uniformly allocated organization identifier and the like. After receiving the first high-layer message, the AP returns the second high-layer message including the group ID information (group ID or Page ID) allocated to the STA, or including the group ID information and the second station ID information allocated to the STA; and the group ID information/the second station ID information can be allocated to the STA by the AP or by a network entity located at the same layer as or at a layer higher than the AP is according to a parameter in the first high-layer message and/or the capability information of the STA acquired from a Probe Request frame and/or an Association Request frame. The second station ID information can be the same as or different from the first station ID information.

When the group ID information is allocated to the STA, the STA performs frame exchanging transmission with the AP using the allocated group ID information and the first station ID information. If the group ID information and the second station ID information are allocated to the STA, the STA performs frame exchanging transmission with the AP using the group ID information and the second station ID information.

### Second Embodiment

There are two ways of allocation in the embodiment, which are, respectively: allocating ID information to an STA during or after reassociation.

Way I: an STA sends a Reassociation Request frame to an AP; and after receiving the Reassociation Request frame, the AP sends the STA a Reassociation Response frame carrying an AID (i.e., first station ID information) allocated to the STA. After the reassociation, the STA performs frame exchanging transmission with the AP using the AID.

After the reassociation, the STA sends a first high-layer message to the AP; and the AP sends a second high-layer message to the STA actively or in response to the first high-layer message from the STA. The first high-layer message includes at least one of the following parameters: a category of application, a provider ID, a power-saving capability, and an operator ID of the STA. After receiving the first high-layer message, the AP returns the second high-layer message including group ID information (Group ID or Page ID) or group ID information and second station ID information allocated to the STA by the AP, or by a network entity located at the same layer as or at a layer higher than the AP is, according to a parameter in the first high-layer message and/or the capability information of the STA acquired from an Association Request frame/ a Reassociation Request frame. If the group ID information is allocated to the STA, the STA performs frame exchanging transmission with the AP using the group ID information and first station ID information. If the group ID information and the second station ID information are allocated to the STA, the STA performs frame exchanging transmission with the AP using the group ID information and the second station ID information.

Way II: druing reassociation, an STA sends a Reassociation Request frame to an AP; and after receiving the Reassociation Request frame, the AP sends a Reassociation Response frame to the STA. If the STA reassociates with an original AP, the original AP has acquired parameters such as a category of application, a provider ID, a power-saving capability, and an operator ID of the STA; or, if the STA reassociates with another AP in the BSS, the new AP can acquire such parameters of the STA from the original AP. When an AP, or a network entity located at the same layer as or at a layer higher than the AP is, saves the parameters locally, the Reassociation Response frame can carry the group ID information and/or the station ID information reallocated to the STA. The STA performs frame exchanging transmission with the AP using the group ID information and/or the station ID information reallocated.

It may be seen that with the terminal-ID allocation method of the disclosure, a terminal in a WLAN can acquire station ID information when accessing the network, and acquire group information or group information and new station ID information by message exchange after accessing the network. Therefore, the method is suitable for an application in which a large number of terminals access and need to be grouped.

The above are only preferred embodiments of the disclosure and not intended to limit the disclosure. For those skilled in the art, various modifications and changes can be made in the disclosure. Any modifications, equivalent replacements, improvements and the like made within the spirit and principle of the disclosure shall fall within the scope of protection of the disclosure.

1. An Identifier (ID) allocation method, comprising:
sending, by a non-AP Station (STA), a first radio frame to an Access Point (AP); and
sending, by the AP, the STA a second radio frame carrying group ID information allocated to the STA, or carrying group ID information and second station ID information allocated to the STA.

2. The method according to claim 1, further comprising: before the sending, by a non-AP Station (STA), a first radio frame to an Access Point (AP),
sending, by the STA, an Association Request frame/a Reassociation Request frame to the AP; and
sending, by the AP, the STA an Association Response frame/a Reassociation Response frame carrying a first station ID information of the STA.

3. The method according to claim 1, wherein
the group ID information carried by the second radio frame is group ID information allocated to the STA by the AP according to an ID allocation parameter carried by the first radio frame and/or capability information of the STA acquired from a Probe Request frame and/or an Association Request frame/a Reassociation Request frame; and
the group ID information and the second station ID information carried by the second radio frame are group ID information and second station ID information allocated to the STA by the AP according to the ID allocation parameter carried by the first radio frame and/or the capability information of the STA acquired from a Probe Request frame and/or an Association Request frame/a Reassociation Request frame;
and the second station ID information can be the same as or different from a first station ID information.

4. The method according to claim 3, wherein
the ID allocation parameter comprises one or more of the following: a category of application, a provider ID, a power-saving capability, and an operator ID of the STA.

5. The method according to claim 1, further comprising: before the sending, by the AP, a second radio frame to the STA, allocating, by the AP or by a network entity located at the same layer as or at a layer higher than the AP is, the group ID information to the STA, or allocating, by the AP or by a network entity located at the same layer as or at a layer higher than the AP is, the group ID information and the second station ID information to the STA.

6. The method according to claim 3, wherein the ID allocation parameter, the group ID information and the second station ID information are carried by a message defined by a Media Access Control (MAC) layer or its upper layer.

7. An Identifier (ID) allocation method, comprising:
sending, by a non-AP Station (STA), a Reassociation Request frame to an Access Point (AP); and
sending, by the AP, the STA a Reassociation Response frame carrying group ID information and/or station ID information reallocated to the STA.

8. The method according to claim 7, further comprising: before the sending, by the AP, a Reassociation Response frame to the STA, reallocating, by the AP or by a network entity located at the same layer as or at a layer higher than the AP is, the group ID information and/or the station ID information to the STA according to an acquired ID allocation parameter and/or capability information of the STA acquired from an Association Request frame/the Reassociation Request frame.

9. The method according to claim 8, wherein
the ID allocation parameter comprises one or more of the following: a category of application, a provider ID, a power-saving capability, and an operator ID of the STA.

10. An Identifier (ID) allocation system, comprising a non-AP Station (STA) and an Access Point (AP), wherein
the STA is configured to send a first radio frame to the AP; and
the AP is configured to send the STA a second radio frame carrying group ID information allocated to the STA, or group ID information and second station ID information allocated to the STA.

11. The system according to claim 10, wherein
the STA is further configured to send an Association Request frame/a Reassociation Request frame to the AP; and
the AP is further configured to send the STA an Association Response frame/a Reassociation Response frame carrying a first station ID information of the STA.

12. The system according to claim 10, wherein the AP is further configured to allocate the group ID information to the STA, or allocate the group ID information and the second station ID information to the STA.

13. The system according to claim 10, further comprising a network entity located at the same layer as or at a layer higher than the AP is, the network entity being configured to: allocate the group ID information to the STA, or allocate the group ID information and the second station ID information to the STA; and send the allocated ID information to the AP.

14. An Identifier (ID) allocation system, comprising a non-AP Station (STA) and an Access Point (AP), wherein
the STA is configured to send a Reassociation Request frame to the AP; and
the AP is configured to send the STA a Reassociation Response frame carrying group ID information and/or station ID information reallocated to the STA.

15. The system according to claim 14, wherein
the AP is further configured to allocate the group ID information and/or the station ID information to the STA.

16. The system according to claim 14, further comprising a network entity located at the same layer as or at a layer higher than the AP is, the network entity being configured to allocate the group ID information and/or the station ID information to the STA and send the allocated ID information to the AP.

17. The method according to claim 4, wherein the ID allocation parameter, the group ID information and the second station ID information are carried by a message defined by a Media Access Control (MAC) layer or its upper layer.

18. The method according to claim 5, wherein the ID allocation parameter, the group ID information and the second station ID information are carried by a message defined by a Media Access Control (MAC) layer or its upper layer.
